(19) United States
(12) Patent Application Publication
(10) Pub. No.: US 2011/0041188 A1
(43) Pub. Date: Feb. 17, 2011

(54) METHOD AND SYSTEM FOR PROTECTION OF COMPUTER APPLICATIONS AND SOFTWARE PRODUCTS AGAINST UNAUTHORIZED COPYING

(75) Inventor: Victor I. Sheymov, Vienna, VA (US)

Correspondence Address: The Villamar Firm PLLC, 3424 Washington Drive, Falls Church, VA, 22041, US

(73) Assignee: INVICTA NETWORKS, INC

(21) Appl. No.: 12/990,166

(22) PCT Filed: Apr. 27, 2009
(86) PCT No.: PCT/US09/41764

§ 371 Date: Oct. 28, 2010

Related U.S. Application Data
(60) Provisional application No. 61/050,043, filed on May 2, 2008.

(51) Int. Cl. G06F 21/00

(52) U.S. Cl. 726/26

(57) ABSTRACT

A method, system, and computer program product for protection of an application or program, including making secret a command or commands that are normally fixed in an operating system (OS) and/or a Basic Input/Output System (BIOS); generating values or names for the command or commands; providing legitimate users and/or devices with the generated values or names for the command or commands for enabling receiving services from the kernel, OS, and/or the BIOS; translating the generated values or names for the command or commands via a translation mechanism provided between an application or program and the kernel, OS, and/or BIOS for enabling receiving services from the kernel, OS, and/SEND or the BIOS; and modifying, changing, and/or replacing the generated values or names employed for the command or commands in the kernel, OS, and/or BIOS.

### CROSS REFERENCE TO RELATED DOCUMENTS

The present invention claims benefit of priority to U.S. Provisional Patent Application Ser. No. 61/050,043 of Sheymov, entitled “METHOD AND SYSTEM FOR PROTECTION OF COMPUTER APPLICATIONS AND SOFTWARE PRODUCTS AGAINST UNAUTHORIZED COPYING,” filed on May 2, 2008, the entire disclosure of which is hereby incorporated by reference herein.

### BACKGROUND OF THE INVENTION

1. Field of the Invention

The present invention generally relates to systems and methods for preventing unauthorized copying, and more particularly to a system and method for protection of computer applications, software products, and the like, from unauthorized copying, and the like.

2. Discussion of the Background

In recent years, software piracy has become a significant problem for a variety of vendors. Although system and methods have been developed to address this problem, such systems are deployed at the application level, and thus do not address potential attacks at other levels. Therefore, there is a need for a robust system and method for protection of computer applications, software products, and the like, from unauthorized copying, and the like, and which handle attacks at various levels.

### SUMMARY OF THE INVENTION

The above and other needs are addressed by the exemplary embodiments of the present invention, which provide a novel system and method for protection of computer applications, software products, and the like, from unauthorized copying, and the like, and which handle attacks at various levels. In an exemplary embodiment, the system and method can include employing a command or commands that are normally fixed in an operating system (OS) and/or a Basic Input/Output System (BIOS) being made secret; providing legitimate users with a variable value, name and the like for such command or commands for enabling receiving services from the kernel, OS, and/or the BIOS; providing a translation mechanism between an application or program and the kernel, OS, and/or BIOS for translating the variable value, name and the like for the command or commands; and modifying, changing, and/or replacing the value, name and the like for the employed command or commands.

Accordingly, in exemplary aspects of the present invention, a method, system and computer program product for protection of an application or program are provided, including making secret a command or commands that are normally fixed in an operating system (OS) and/or a Basic Input/Output System (BIOS); generating values or names for the command or commands; providing legitimate users and/or devices with the generated values or names for the command or commands for enabling receiving services from the kernel, OS, and/or the BIOS; translating the generated values or names for the command or commands via a translation mechanism provided between an application or program and the kernel, OS, and/or BIOS for enabling receiving services from the kernel, OS, and/or the BIOS; and modifying, changing, and/or replacing the generated values or names employed for the command or commands in the kernel, OS, and/or BIOS.

Still other aspects, features, and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 illustrates a legacy or background art security system for preventing unauthorized copying of a software application;

FIG. 2 illustrates an exemplary system for protection of computer applications, software products, and the like, from unauthorized copying, and the like, and which handle attacks at various levels; and

FIG. 3 illustrates an exemplary process corresponding to the system of FIG. 2.

### DETAILED DESCRIPTION OF THE INVENTION

The present invention includes recognition that software piracy has become a significant problem for a variety of vendors. Accordingly, the exemplary embodiments of the present invention include a novel method and system for protecting, for example, software programs, operating systems, and the like, of computers or other computing devices, and the like, from unauthorized copying, and the like.

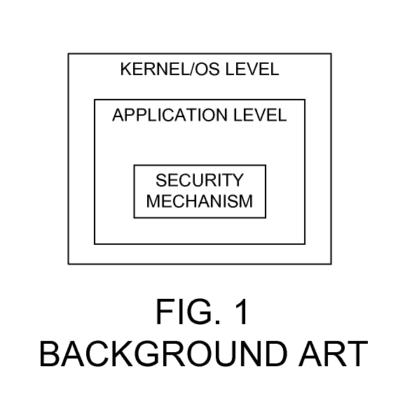

As illustrated in FIG. 1, a problem encountered by legacy and background art security systems and mechanisms is that they are built at the application level. As such, sophisticated hackers are able to defeat such security arrangements and mechanisms, for example, by going directly to a kernel of an operating system (OS), and the like. In this way, the entire licensing, security, and the like, mechanism can be bypassed, irrespective of the sophistication of the security algorithm, length of encryption and other keys or passwords, and the like, employed.

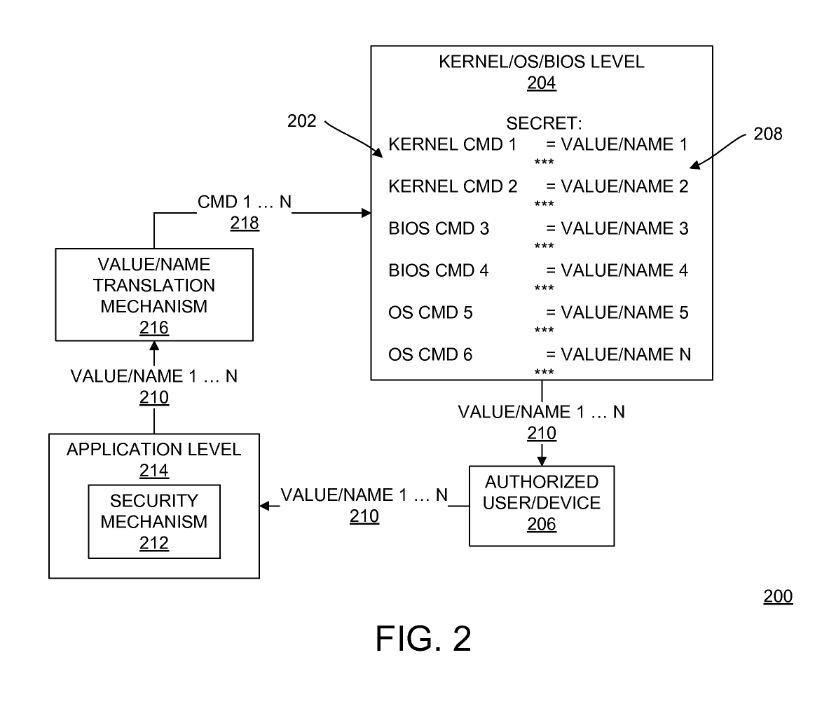

Referring now to the drawings, FIG. 2 thereof illustrates an exemplary system 200 for protection of computer applications, software products, and the like, from unauthorized copying, and the like, and which handle attacks at various levels. In FIG. 2, the system 200 can be used to solve the above and other problems with legacy security systems and methods, wherein the exemplary embodiments of the present invention include the use of “variable commands” 202, which in an exemplary embodiment can include a command or commands that are normally fixed in an operating system, a Basic Input/Output System (BIOS), and the like 204, being made secret (e.g., not publicly known or available, etc.). Legitimate, authorized, and the like, users and/or devices 206 are given a generated value, name, and the like 208 at 210 of such a variable command or commands 202, enabling receiving services from the kernel, OS, BIOS, and the like 204. Advantageously, unauthorized users would not know the value, name, and the like 208 of such commands 202 for enabling the services of the kernel, BIOS, OS, and the like 204, and thus would not be able to bypass any suitable security arrangements 212 (e.g., licensing mechanism) of a given application 214. In exemplary embodiments, a “command translation” mechanism 216 can be employed between the application 214 and the kernel, OS, BIOS, and the like 204 to generate the translated command at 218. In addition, the value, name, and the like 208 of the employed commands 202 in the kernel, OS, BIOS, and the like 204, can be modified, changed, replaced, and the like. Such a security arrangement can be made in a way that the modified (e.g., secret) value, name, and the like 208 is employed only from one or more specific applications or programs, from all applications or programs, and the like.

In further exemplary embodiments, to further improve security of such an arrangement, the secret value, name, and the like 208 can made variable and from time to time communicated only to authorized parties, devices, and the like 206. Advantageously, this can be employed as an effective, periodic continuation of a license, and the like, to use an application, a program, an operating system, content, and the like.

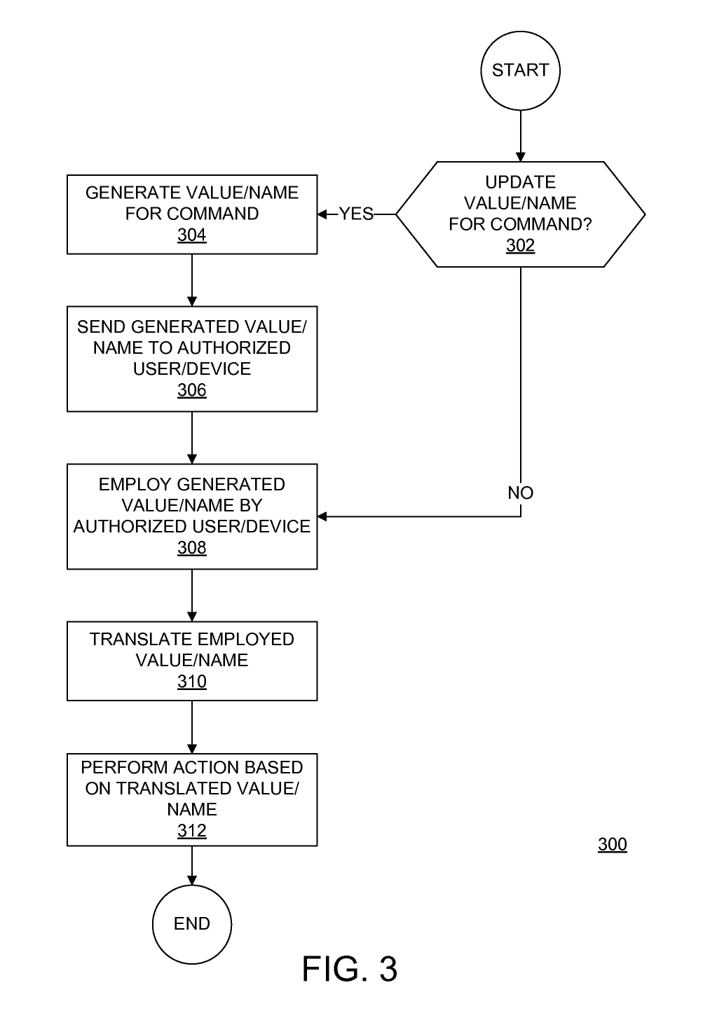

FIG. 3 illustrates an exemplary process 300 corresponding to the system of FIG. 2. In FIG. 3, step 302 determines if the values, names, and the like 208 should be generated or regenerated for the commands 202. If so, step 304 generates the values, names, and the like 208 for the commands 202 and step 306 sends the generated values, names, and the like 208 to the authorized users and/or devices 206 and control is transferred to step 308. If step 302 determines that the values, names, and the like 208 should not be generated or regenerated for the commands 202, control is transferred to step 308. At step 308, the authorized users and/or devices 206 employ the generated values, names, and the like 208 and which are translated at step 310 by the command translation mechanism 216 before being sent to the kernel, OS, BIOS, and the like 204. At step 312, the corresponding action based on the translated command is performed, completing the process.

The above-described devices and subsystems of the exemplary embodiments can be accessed by or included in, for example, any suitable servers, clients, workstations, PCs, laptop computers, PDAs, Internet appliances, handheld devices, cellular telephones, wireless devices, other devices, and the like, capable of performing, accessing or employing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, G3 communications networks, Public Switched Telephone Network (PSTNs), Packet Data Networks (PDNs), the Internet, intranets, WiMax Networks, a combination thereof, and the like

It is to be understood that the devices and subsystems of the exemplary embodiments are for exemplary purposes, as many variations of hardware and/or software used to implement the exemplary embodiments are possible, as will be appreciated by those skilled in the relevant art(s). For example, the functionality of one or more of the devices and subsystems of the exemplary embodiments can be implemented via one or more programmed computer systems or devices.

To implement such variations as well as other variations, a single computer system can be programmed to perform special purpose functions of one or more of the devices and subsystems of the exemplary embodiments. On the other hand, two or more programmed computer systems or devices can be substituted for any one of the devices and subsystems of the exemplary embodiments. Accordingly, principles and advantages of distributed processing, such as redundancy, replication, and the like, also can be implemented, as desired, to increase the robustness and performance of the devices and subsystems of the exemplary embodiments.

The devices and subsystems of the exemplary embodiments can store information relating to various processes described herein. This information can be stored in one or more memories, such as a hard disk, optical disk, magneto-optical disk, RAM, and the like, of the devices and subsystems of the exemplary embodiments. One or more databases of the devices and subsystems of the exemplary embodiments can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases thereof.

All or a portion of the devices and subsystems of the exemplary embodiments can be conveniently implemented using one or more general purpose computer systems, microprocessors, digital signal processors, micro-controllers, and the like, programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present inventions can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the devices and subsystems of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

Although the exemplary embodiments can be described in terms of a Basic Input/Output System (BIOS), the exemplary embodiments can be employed with Open Firmware, Extensible Firmware Interface, coreboot, an application programming interface (API), and the like, as will be appreciated by those skilled in the electrical and software arts.

While the present invention have been described in connection with a number of exemplary embodiments and implementations, the present invention is not so limited, but rather covers various modifications and equivalent arrangements, which fall within the purview of the appended claims.

What is claimed is:

1. A computer implemented method for protection of an application or program, the method comprising:
making secret a command or commands that are normally fixed in an operating system (OS) and/or a Basic Input/Output System (BIOS);
generating values or names for the command or commands;
providing legitimate users and/or devices with the generated values or names for the command or commands for enabling receiving services from the kernel, OS, and/or the BIOS;
translating the generated values or names for the command or commands via a translation mechanism provided between an application or program and the kernel, OS, and/or BIOS for enabling receiving services from the kernel, OS, and/or the BIOS; and
modifying, changing, and/or replacing the generated values or names employed for the command or commands in the kernel, OS, and/or BIOS.

2. A computer implemented system for protection of an application or program, the system comprising:
means for making secret a command or commands that are normally fixed in an operating system (OS) and/or a Basic Input/Output System (BIOS);
means for generating values or names for the command or commands;
means for providing legitimate users and/or devices with the generated values or names for the command or commands for enabling receiving services from the kernel, OS, and/or the BIOS;
a translation mechanism provided between an application or program and the kernel, OS, and/or BIOS for translating the generated values or names for the command or commands for enabling receiving services from the kernel, OS, and/or the BIOS; and
means for modifying, changing, and/or replacing the generated values or names employed for the command or commands in the kernel, OS, and/or BIOS.

3. A computer program product for protection of an application or program, and including one or more computer readable instructions embedded on a computer readable medium and configure to cause one or more computer processors to perform the steps of:
making secret a command or commands that are normally fixed in an operating system (OS) and/or a Basic Input/Output System (BIOS);
generating values or names for the command or commands;
providing legitimate users and/or devices with the generated values or names for the command or commands for enabling receiving services from the kernel, OS, and/or the BIOS;
translating the generated values or names for the command or commands via a translation mechanism provided between an application or program and the kernel, OS, and/or BIOS for enabling receiving services from the kernel, OS, and/or the BIOS; and
modifying, changing, and/or replacing the generated values or names employed for the command or commands in the kernel, OS, and/or BIOS.
